(19) United States
(12) Patent Application Publication
(10) Pub. No.: US 2008/0222241 A1
(43) Pub. Date: Sep. 11, 2008

(54) Web feed message browsing

(76) Inventors: Peter Arvai, Stockholm (SE); Joacim Boivie, Haninge (SE); Joakim Hilj, Stockholm (SE)

Correspondence Address: LESTER H. BIRNBAUM, 6 OAKMOUNT COURT, SIMPSONVILLE, SC, 29681, US

(21) Appl. No.: 11/716,376

(22) Filed: Mar. 9, 2007

(51) Int. Cl. G06F 15/16; G06F 3/00

(52) U.S. Cl. 709/203; 715/738

(57) ABSTRACT

The present invention describes a method and a system for facilitating browsing of web feed messages in a network. Web feed message is received by a feed aggregator. The received web feed message is linked to other web feed messages based on a pre-defined criterion. The linked web feed message is sent to a computational device for display. The linked web feed message facilitates browsing of web feed messages in a network.

### BACKGROUND OF THE INVENTION

The invention relates to web feed messages. More specifically, the invention relates to a method for facilitating browsing of web feed messages in a network.

Web content distributors publish information on their websites. This information may include for example, the latest news, weather reports, sports updates and the like. Web content distributors constantly update the published information and add new content to their websites. In order to obtain the latest published information added by the web content distributors, information seekers need to visit the individual websites frequently. Further, the additions made to the content need to be identified in the existing published information.

To solve this difficulty, web content distributors provide web feeds on their websites. The web feeds provide the information seekers with a channel for the latest published information added to the website. To obtain the web feeds, information seekers subscribe to the web content by using a feed reader. The feed reader regularly checks the web feeds for any new content. The new content is received by the feed reader in the form of a web feed message. Feed messages are also generally known in the art as “updates” or “posts”. For example, web content distributors provide syndicated web content in Rich Site Summary (RSS) and Atom feed format. The information seekers can register with the web content distributors by using an RSS feed reader to receive the latest published information thereby eliminating the need to check individual websites for updates. Examples of commercially available feed readers include NewsGator, FeedDemon, and the like.

However, existing web feed messages provide stand-alone content and do not offer any additional information desired by the information seeker. For instance, the information seeker may seek additional publications on a popular word in the web feed message. Further, existing web feed messages do not provide additional information related to the topic, for example, links to other relevant published articles.

In light of the foregoing, there is a need for a method that facilitates browsing of web feed messages, so that information seekers may pursue further information should they desire more information on the topics contained in feeds and their messages.

### SUMMARY

An object of the invention is to facilitate browsing of web feed messages in a network.

Another object of the invention is to provide additional information related to the web feed message.

Yet another object of the invention is to provide users with relevant additional information.

In order to achieve the above-mentioned objectives, a method and system for facilitating browsing of web feed messages in a network is provided. Web content distributors provide web feeds, publishing their latest updates to existing web content. Users of computational devices subscribe to web content by clicking on links relating to the web feed or by searching the directory of a feed reader. The feed reader receives regular updates to the web content in the form of web feed messages. A received web feed message is linked to related web feed messages, based on a pre-defined criterion. The pre-defined criterion may include keyword-based relevance of the related web feed messages, their contextual relevance, network's preference, the network's treatment of certain messages and the like. The linked web feed message is sent to the computational device for display.

The linked web feed message facilitates browsing of web feed messages. Users of computational devices may use the links to the web feed messages provided in the web feed message to receive additional information or information related to the web feed message. For example, the linked web feed message may provide links to other relevant published articles and such other reading suggestions.

### BRIEF DESCRIPTION OF THE DRAWINGS

Various embodiments of the invention will hereinafter be described in conjunction with the appended drawings, provided to illustrate and not to limit the invention, wherein like designations denote like elements, and in which:

FIG. 1 is a block diagram of an environment in which various embodiments of the invention may be practiced;

FIG. 2 illustrates a system for facilitating browsing of web feed messages in a network in accordance with an embodiment of the invention;

FIG. 3 is a flowchart illustrating a method for facilitating browsing of web feed messages in a network in accordance with an embodiment of the invention; and

FIG. 4 is an illustration of a linked web feed message in accordance with an embodiment of the invention.

### DETAILED DESCRIPTION OF THE INVENTION

The invention provides a method, system and a computer program product for facilitating browsing of web feed messages in a network. Web feed messages contain updated information desired by users of computational devices. In accordance with the method and system of the invention, web feed messages are received by a feed aggregator. The feed aggregator links the web feed message to other web feed messages based on a pre-defined criterion. The other web feed messages are related to the web feed message. The linked web feed message is sent to a computational device for display. Linking of web feed messages facilitates browsing of web feed messages in a network.

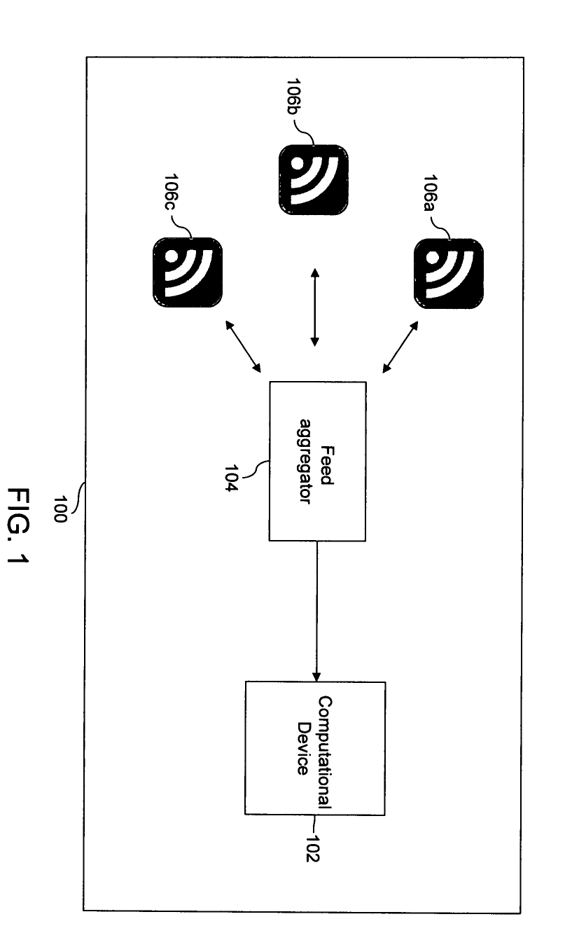

FIG. 1 is a block diagram of an environment 100 in which various embodiments of the invention may be practiced. Environment 100 includes a computational device 102, a feed aggregator 104 and a plurality of web content distributors such as web content distributor 106a, web content distributor 106b and web content distributor 106c. Web content distributors 106a, 106b and 106c are hereinafter referred to as web content distributors 106. Users of computational device 102 register with web content distributors 106 to receive web feed messages. Web content distributors 106 syndicate web content and provide syndicated web content in the form of a web feed link. Users of computational device 102 subscribe to the web content provided by web content distributors 106 by adding the web feed link to feed aggregator 104. Feed aggregator 104 receives the web feed message from web content distributors 106 and links the web feed message to other web feed messages based on a pre-defined criterion. The other web feed messages include web feed messages in the network. In accordance with an embodiment of the invention, these are stored in a database (not shown in the figure) which may be accessed by feed aggregator 104. The linked web feed message is sent to computational device 102.

Examples of computational device 102 may include a computer, a laptop, a mobile communication device, a personal digital assistant (PDA) and any such device but are not limited to those mentioned above. It may be evident to a person skilled in the art that the web feed message may include web content such as news articles, sports updates, weather reports, podcasts or any such information provided by web content distributors 106. Examples of web content distributors 106 may include website providers, blog site providers, radio stations or any such web content providers offering web feeds.

In accordance with an embodiment of the invention, the web feed message is an RSS message. It will be apparent to those skilled in the art that the RSS web feed message may include a Rich Site Summary web feed message (RSS 0.91, 1.0), an RDF (Resource Description Framework) Site Summary (RSS 0.9, 1.0), a Really Simple Syndication web feed message (RSS 2.0), and any variation or upgrade of the RSS web feed format. In accordance with another embodiment of the invention, the web feed message is an Atom web feed message.

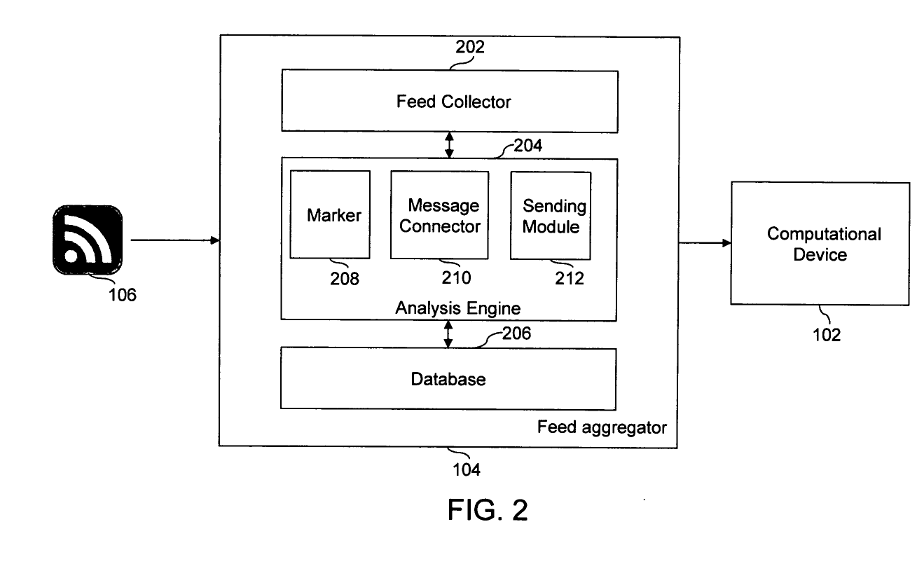

In accordance with an embodiment of the invention, feed aggregator 104 may be included in computational device 102. In accordance with another embodiment of the invention, feed aggregator 104 may be provided by web content distributors 106. Feed aggregator 104 is explained in detail in conjunction with FIG. 2.

FIG. 2 illustrates a system for facilitating browsing of web feed messages in a network, in accordance with an embodiment of the invention. In FIG. 2, feed aggregator 104 is the system for facilitating browsing of web feed messages. Feed aggregator 104 includes a feed collector 202, an analysis engine 204 and a database 206. Analysis engine 204 includes a marker 208, a message connector 210 and a sending module 212.

Feed collector 202 checks a web feed link provided by web content distributors 106 for new content. New content added by web content distributors 106 is received by feed collector 202 as a web feed message. Database 206 stores the web feed messages received by feed collector 202 from web content distributors 106. The received web feed message is forwarded to analysis engine 204. Marker 208 marks at least one section of the web feed message, which may include a word, a line, a paragraph, or any combination thereof. Message connector 210 links the marked section of the web feed message with other web feed messages based on the pre-defined criterion. The other web feed messages may include the web feed messages stored in database 206, web feed messages received from a library of web content distributors 106 and the like. Sending module 212 sends the linked web feed message to the computational device for display. The user of computational device 102 may browse the displayed linked web feed message.

In accordance with an embodiment of the invention, feed collector 202 may access web content distributors 106, to identify new content that has been added to existing web content. In accordance with another embodiment of the invention, feed collector 202 may be scheduled to check any added new content by web content distributors 106, at a pre-defined time interval. In accordance with another embodiment of the invention web content distributors 106 may send the web feed message to feed collector 202 on the addition of new content to the existing web content.

In accordance with an embodiment of the invention, web feed messages stored by database 206 may include the web feed messages received from web content distributors 106 to which the recipient of the web feed message has subscribed. In accordance with an embodiment of the invention, web feed messages stored by database 206 may include the web feed messages received from the library of web content distributors 106.

In accordance with various embodiments of the invention, feed aggregator 104, feed collector 202, analysis engine 204, database 206, marker 208, message connector 210 and sending module 212 may be implemented as a hardware module, software, firmware or a combination thereof.

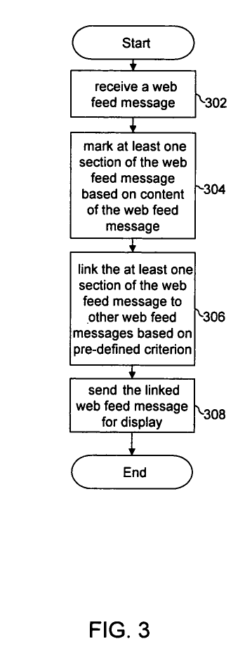

FIG. 3 is a flowchart illustrating a method for facilitating browsing of web feed messages in a network, in accordance with an embodiment of the invention. At step 302, a web feed message is received by a feed collector such as feed collector 202. The feed collector collects the web feed messages from a web content distributor such as web content distributors 106. At step 304, a marker such as marker 208 marks at least one section of the received web feed message based on the content of the web feed message. For example, the marker identifies keywords in a web feed message based on the content of a particular web feed subscribed by the user of the computational device or based on a personalized selection of data by the user. The marked sections of the feed message are then used for linking. Marking the at least one section of the web feed message may include hyper linking the marked section and the like. At step 306, a message connector such as message connector 210 links the at least one section of the web feed message with other web feed messages based on a pre-defined criterion. Examples of linking the at least one section of the web feed message may be hyper linking the at least one section of the web feed message and providing links for suggested readings, visual maps of message connections and the like. At step 308, the sending module such as sending module 212, sends the linked web feed message to computational device 102 for display.

In accordance with an embodiment of the invention, the marker identifies and marks the keywords in the web feed message based on the content of the web feed message. In accordance with another embodiment of the invention, the marker identifies keywords based on personalized selection of collated user data such as web links frequently visited by the user of the computational device.

In accordance with various embodiments of the invention, the pre-defined criterion may be keyword-based relevance of the web feed message to the other web feed messages, contextual relevance of the web feed message to the other web feed messages, feed relevance and the like. The keyword relevance of the web feed message may be based on search words that are commonly used by the users, search words used by web feed message readers, words that are common to all web feed messages or those that are common to users' subscribed feeds and the like. Relevance of web feeds to one another may be based on subscriptions that are common to web feed message readers. For instance, web feed message readers subscribing to a particular news feed may also subscribe to a weather forecast feed.

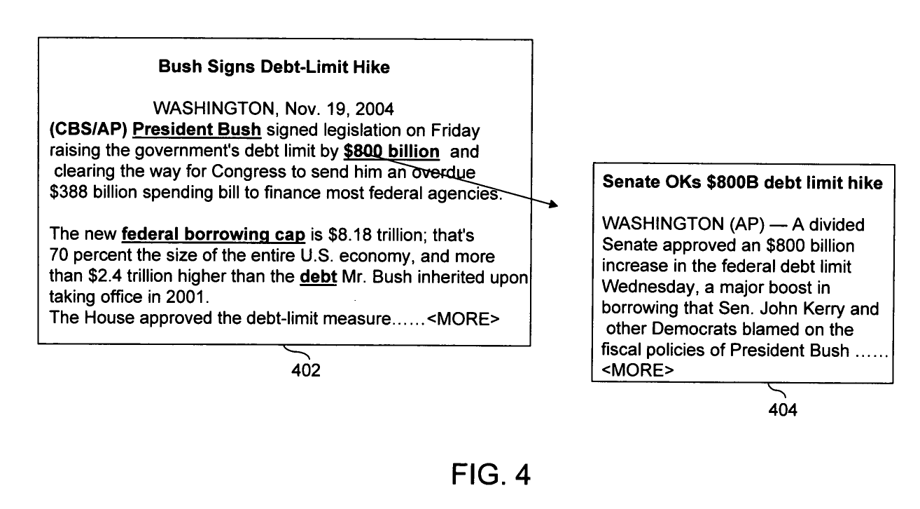

An illustration of the method and system for linking the web feed message with other web feed messages is explained in conjunction with FIG. 4.

FIG. 4 is an illustration of a linked web feed message, in accordance with an embodiment of the invention. Screenshot 402 captures the linked web feed message displayed on computational device 102. As shown, the keywords ‘President Bush’, ‘federal borrowing cap’, “debt” and ‘$800 billion’ are hyperlinked, based on popular keywords and the context of the news article in the web feed message. A user of computational device 102 on clicking on these words, is directed to a related web feed message represented by screenshot 404. Screen shot 404 provides updates provided by another web content distributor.

In this example, the user of computational device 102 has registered with web content distributors 106 offering news web feed links. Feed collector 202 collects new content from news web feed links in the form of a news article. Marker 208 identifies popular keywords in the news article such as ‘President Bush’ and hyper links them. Marker 208 also identifies the context of the article as relating to finance policy and hyper links keywords ‘$800 billion’, “debt” and ‘federal borrowing cap’. Message connector 210 links hyper linked sections of the web feed message to other web feed messages based on the pre-defined criterion such as that mentioned previously. Screenshot 404 illustrates a web feed message linked to web feed message displayed in screenshot 402, based on the contextual relevance of the keywords identified. The user of computational device 102 clicks on the hyper linked sections of the web feed message and is directed to the linked web feed message such as that captured in screenshot 404.

In accordance with an embodiment of the invention, the web feed message may be appended with links relating to suggested reading or displaying a map of related messages or feeds. The user of computational device 102 may scroll the web feed message to check the suggested reading and click on it to browse for additional information.

A computer system which may utilize the invention comprises a computer, an input device, a display unit and the Internet. The computer may comprise a microprocessor. The microprocessor is connected to a communication bus. The computer also includes a memory. The Memory may include Random Access Memory (RAM) and Read Only Memory (ROM). The computer system further comprises a storage device which can be a hard disk drive or a removable storage drive such as a floppy disk drive, optical disk drive and the like. The storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for browsing of web feed messages in a network, the method comprising:
a. receiving a web feed message;
b. linking the web feed message to other web feed messages based on a pre-defined criterion; and
c. sending the linked web feed message for display to a user, the linked web feed message facilitating browsing.

2. The method according to claim 1, wherein the web feed message is an RSS web feed message.

3. The method according to claim 1, wherein the web feed message is an Atom web feed message.

4. The method according to claim 1, wherein the pre-defined criterion comprises relevance of the web feed message to other web feed messages.

5. The method according to claim 1, wherein the pre-defined criterion comprises keywords related to the web feed message.

6. The method according to claim 1, wherein the pre-defined criterion comprises user data based on personalized selection of content.

7. The method according to claim 1, wherein linking the web feed message comprises marking at least one section of the web feed message based on content of the web feed message.

8. The method according to claim 7, wherein marking the at least one section of the web feed message is based on key words in the web feed message.

9. The method according to claim 7, wherein marking the at least one section of the web feed message comprises hyper linking the at least one section of the web feed message.

10. The method according to claim 1, wherein the web feed message is sent to the user of a mobile communication device for display.

11. A system for browsing of web feed messages, the system comprising:
a. a feed collector, the feed collector receiving a web feed message;
b. a database, the database storing other web feed messages; and
c. an analysis engine, the analysis engine linking the web feed message and other web feed messages based on a pre-defined criterion.

12. The system as claimed in claim 11, wherein the web feed message is an RSS web feed message.

13. The system as claimed in claim 11, wherein the web feed message is an Atom web feed message.

14. The system as claimed in claim 11, wherein the analysis engine comprises:
a. a marker, the marker marking at least one section of the web feed message based on content of the web feed message; and
b. a message connector, the message connector connecting the at least one section of the web feed message to other web feed messages.

15. The system as claimed in claim 14, wherein the analysis engine further comprises a sending module, the sending module sending the linked web feed message to a mobile communication device.

16. A computer program product for use with a computational device, the computer program product comprising a computer usable medium having a computer readable program embodied therein for browsing of web feed messages in a network, the computer program code performing:
a. receiving a web feed message;
b. linking the web feed message to other web feed messages based on a pre-defined criterion; and
c. sending the linked web feed message for display to a user, the linked web feed message facilitating browsing.

17. The computer program product according to claim 16, wherein the computer readable program code further performing marking at least one section of the web feed message based on content of the web feed message.

18. The computer program product according to claim 17, wherein the computer readable program code performing marking the at least one section of the web feed message further performs hyper linking the at least one section of the web feed message.

19. The computer program product according to claim 16, wherein the computer readable program code further performs computing the relevance of the web feed message to other web feed messages.

20. The computer program product according to claim 16, wherein the pre-defined criterion comprises relevance of the web feed message to other web feed messages.
